(19) United States
(12) Patent Application Publication
(10) Pub. No.: US 2026/0138436 A1
(43) Pub. Date: May 21, 2026

(54) VARIABLE TRANSMISSION SYSTEM FOR HYBRID ELECTRIC VEHICLE

(71) Applicant: XIAMEN NEVC ADVANCED ELECTRIC POWERTRAIN TECHNOLOGY INNOVATION CENTER, Xiamen, Fujian (CN)

(72) Inventors: Zhihui DUAN, Xiamen, Fujian (CN); Jie XING, Xiamen, Fujian (CN); Shanodong YANG, Xiamen, Fujian (CN); Jing LIN, Xiamen, Fujian (CN); Lianghui YANG, Xiamen, Fujian (CN)

(21) Appl. No.: 18/866,677

(22) PCT Filed: May 30, 2023
(86) PCT No.: PCT/CN2023/096979

§ 371 Date: Jul. 18, 2025

(30) Foreign Application Priority Data
Jun. 1, 2022 (CN) 202210616403.3

(51) Int. Cl. B60K 6/36; B60K 6/26; B60K 6/387; B60K 6/442; B60K 6/547; B60K 17/06

(52) U.S. Cl. CPC B60K 6/36; B60K 6/26; B60K 6/387; B60K 6/442; B60K 6/547; B60K 17/06

(57) ABSTRACT

A variable transmission system for a hybrid electric vehicle includes an input shaft connected to an engine and sleeved with first and second gears, and a first synchronizer connected to the input shaft. Third and fourth gears sleeve an output shaft, and a second synchronizer is connected to the output shaft. A shaft of a first motor is connected to a fifth gear and a sixth gear, the fifth, first, and third gears drive each other, the sixth, second, and fourth gears drive each other, and a shaft of a second motor is connected to the output shaft via a transmission mechanism.

### CROSS-REFERENCE TO RELATED APPLICATIONS

The present disclosure is a national phase entry of International Patent Application No. PCT/CN2023/096979, filed on May 30, 2023, which claims priority to Chinese Patent Application No. 202210616403.3, filed on Jun. 1, 2022. International Patent Application No. PCT/CN2023/096979 and Chinese Patent Application No. 202210616403.3 are incorporated herein by reference.

### TECHNICAL FIELD

The present invention relates to the field of hybrid electric vehicle powertain technologies, particularly to a variable transmission system for a hybrid electric vehicle.

### BACKGROUND

Nowadays, the hybrid electric vehicle has become an important development direction of new energy vehicles due to advantages such as energy saving, environmental protection, and no range anxiety. The hybrid electric variable transmission system is one of the core technologies of the hybrid electric vehicle.

Due to the relatively simple structure and low technical difficulty of the series-parallel hybrid electric variable transmission system, it is widely used in domestic car enterprises. The series-parallel hybrid electric variable transmission system typically includes an engine, a generator, a motor, a locking clutch, a reduction gear, and the like. The generator is connected to a shaft of the engine, and the locking clutch can connect the shaft of the engine and the output shaft. The motor drives the vehicle via an acceleration gear. When the clutch is disengaged, the generator converts the power output by the engine into electrical energy, which is rectified and inverted, and then the motor converts the electrical energy into driving torque that acts on the wheels, achieving electric transmission. When the clutch is locked, the power output by the engine is directly transmitted through the reduction gear to drive the vehicle, achieving mechanical transmission. The advantage of electric transmission is that the engine is completely decoupled from the wheels, allowing the engine to operate in its optimal operating mode; its drawback is that the engine's output power undergoes several energy conversions, resulting in energy loss and reduced transmission efficiency. The advantage of mechanical transmission is that torque is transmitted through the gear, resulting in high transmission efficiency; its drawback is that the engine rotation speed is locked to the wheel rotation speed.

As a result, the operating point of the engine is determined by the vehicle speed, and the engine cannot be kept in the optimal operating mode, with low efficiency. Another drawback of the series-parallel hybrid electric system is that during low-speed serial driving, the torque of the engine cannot contribute to vehicle acceleration, thus limiting the acceleration of the vehicle.

To overcome the drawbacks of the series-parallel hybrid variable transmission system, efforts have been made to develop a multi-gear series-parallel hybrid electric transmission system to improve the operating point of the engine, engine efficiency, and overall vehicle acceleration performance.

On Jan. 10, 2020, a Chinese invention application with application No. 201910956880.2, titled “VARIABLE TRANSMISSION SYSTEM FOR HYBRID ELECTRIC VEHICLE,” was published. It includes an engine (1), a first motor (3), a second motor (4), a second motor transmission assembly (5), a first clutch (6), a dual-clutch assembly (7), a first gear-position gear set (8), a second gear-position gear set (9), a third gear-position gear set (10), a synchronizer (11), a first input shaft (13), and a second input shaft (14). The engine (1) is connected to the first clutch (6) and the first clutch (6) is connected to the first motor (3) and the first input shaft (13). One end of the dual-clutch assembly (7) is connected to the first input shaft (13), and the other end is connected to the second input shaft (14). The second motor (4) is connected to the third gear-position gear set (10). Configuring three clutches and three gear positions reduces the demand for power sources while enabling multiple working modes for efficient operation. However, even with the three clutches, this variable transmission system still has a limited number of gear shifts and needs to improve fuel economy, with the overall structure being relatively complex.

Additionally, a large portion of the existing series-parallel hybrid electric variable transmission systems cannot achieve seamless shifting without power interruption in both pure EV (electric vehicle) and HEV (hybrid electric vehicle) operating modes, reducing the smoothness of vehicle driving.

### SUMMARY

To resolve the technical problem, the present invention provides a variable transmission system for a hybrid electric vehicle with a simple and compact structure, which in both EV and HEV operating modes can shift the gear without power interruption, enhancing the smoothness of the vehicle driving; and switch multiple gear positions, improving the engine fuel economy.

To achieve the foregoing objective, the present invention provides the following technical solution: A variable transmission system for a hybrid electric vehicle is provided, including an engine, a first motor, a second motor, an input shaft, an output shaft, a first synchronizer, and a second synchronizer, the input shaft being connected to the engine. A first gear and a second gear sleeve the input shaft, the first synchronizer is connected to the input shaft, and the input shaft is connected to or disconnected from the first gear or the second gear via the first synchronizer. A third gear and a fourth gear sleeve the output shaft, the second synchronizer is connected to the output shaft, and the output shaft is connected to or disconnected from the third gear or the fourth gear via the second synchronizer.

A shaft of the first motor is connected to a fifth gear and a sixth gear, the fifth gear, the first gear, and the third gear drive each other, the sixth gear, the second gear, and the fourth gear drive each other, and a shaft of the second motor is connected to the output shaft via a transmission mechanism.

Preferably, the fifth gear meshes with both the first gear and the third gear, and the first gear does not mesh with the third gear; and the sixth gear meshes with both the second gear and the fourth gear, and the second gear does not mesh with the fourth gear.

Further, the sixth gear includes two gears that are connected as a whole, a first gear of the sixth gear meshes with the second gear, and a second gear of the sixth gear meshes with the fourth gear. This facilitates the design of a proper speed ratio.

Preferably, the third gear meshes with both the first gear and the fifth gear, and the first gear does not mesh with the fifth gear; and the fourth gear meshes with both the second gear and the sixth gear, and the second gear does not mesh with the sixth gear.

Further, the fourth gear includes two gears that are connected as a whole, a first gear of the fourth gear meshes with the second gear, and a second gear of the fourth gear meshes with the sixth gear. This facilitates the design of a proper speed ratio.

Preferably, the first gear meshes with both the third gear and the fifth gear, and the third gear does not mesh with the fifth gear; and the second gear meshes with both the fourth gear and the sixth gear, and the fourth gear does not mesh with the sixth gear.

Further, the second gear includes two gears that are connected as a whole, a first gear of the second gear meshes with the sixth gear, and a second gear of the second gear meshes with the fourth gear. This facilitates the design of a proper speed ratio.

Preferably, the transmission mechanism includes a seventh gear connected to the shaft of the second motor and an eighth gear connected to the output shaft, and the seventh gear meshes with the eighth gear. In this way, the second motor can directly drive the output shaft by meshing the seventh gear with the eighth gear.

According to further improvement, the variable transmission system further includes a first transmission shaft and a second transmission shaft. The first transmission shaft is connected to the shaft of the first motor, and the fifth gear and the sixth gear are connected to the first transmission shaft. The second transmission shaft is connected to the shaft of the second motor, and the seventh gear is connected to the second transmission shaft.

As a change, the first synchronizer and/or the second synchronizer is replaced with a clutch.

The variable transmission system has one or more of the following operation modes:
a pure electric mode: the first motor and/or the second motor drives the output shaft and is able to achieve power shifting;
a series mode: the engine drives the first motor to generate electricity, and the second motor drives the output shaft; and
a parallel mode: the engine drives the output shaft based on a selected gear position, and the first motor and the second motor are separately able to drive, generate electricity, or idle and achieve gear shifting.

The present invention has the following beneficial effects:

1. The use of the variable transmission mechanism consisting of parallel shafts and gears, with only two pairs of synchronizers, featuring mature technologies and low costs, can achieve four gear positions for the engine, optimize the operating mode of the engine, and improve the efficiency. The first motor has two gear positions, balancing high thrust and high speed; a moderate gear ratio can be set for the second motor, providing good thrust and efficiency at a medium speed.

2. In the HEV (hybrid electric vehicle) operating mode, during shifting, the second motor maintains driving, the first motor drags the engine to adjust the speed, and after synchronization, the synchronizer directly engages the gear, achieving power shifting without power interruption, with a smooth process and a simple system. In the pure EV (electric vehicle) operating mode, the second motor and the first motor cooperate to achieve power shifting without power interruption, with a smooth process and good comfort, ensuring smooth vehicle driving.

3. Both motors can be separated from the engine, so in the EV operating mode, both motors can drive simultaneously, allowing the torque and power of the two motors to be reduced, thus lowering costs, and reducing the weight and volume.

4. After the synchronizer engages the gear, no additional energy is consumed. After disengaging, the residual resistance is small, resulting in minimal energy loss, which helps improve the system efficiency.

5. The shift execution mechanism is simple, convenient to control, and has a single type, resulting in low costs.

6. In the variable transmission system, the first motor can perform multiple functions: driving the output shaft for pure electric output; serving as a starter motor to start the engine; acting as a generator to charge the power battery after the engine starts; and participating in synchronization, facilitating the engagement of the first synchronizer with the first gear or the second gear, and the engagement of the second synchronizer with the third gear or the fourth gear. Thus, the present invention reduces the configured components, making the overall structure more compact.

### BRIEF DESCRIPTION OF DRAWINGS

FIG. 1 is a schematic structural diagram according to a first embodiment of the present invention.

FIG. 2 is a schematic structural diagram according to a second embodiment of the present invention.

FIG. 3 is a schematic structural diagram according to a third embodiment of the present invention.

FIG. 4 is a schematic structural diagram according to a fourth embodiment of the present invention.

### DESCRIPTION OF EMBODIMENTS

The present invention is further described in detail below with reference to the accompanying drawings and specific embodiments.

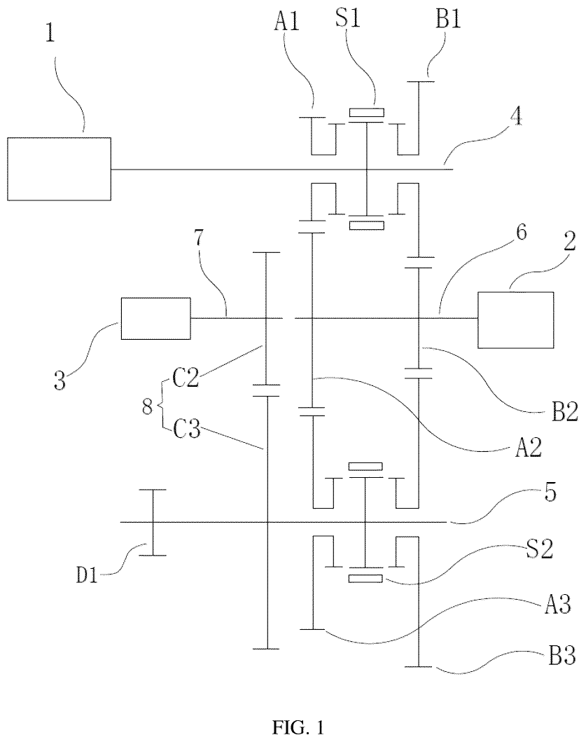

In Embodiment 1, as shown in FIG. 1, a variable transmission system for a hybrid electric vehicle is provided, including an engine 1, a first motor 2, a second motor 3, an input shaft 4, an output shaft 5, a first transmission shaft 6, a second transmission shaft 7, a first synchronizer S1, and a second synchronizer S2. The input shaft 4 is connected to the engine 1, and a first gear A1 and a second gear B1 sleeve the input shaft 4. The first synchronizer S1 is connected to the input shaft 4, and the input shaft 4 is connected to or disconnected from the first gear A1 or the second gear B1 via the first synchronizer S1. Specifically, as shown in FIG. 1, when the first synchronizer S1 moves left to engage the first gear A1, the input shaft 4 is connected to the first gear A1. When the first synchronizer S1 moves right to engage the second gear B1, the input shaft 4 is connected to the second gear B1. When the first synchronizer S1 is in the middle position, the input shaft 4 is not connected to either the first gear A1 or the second gear B1. A third gear A3 and a fourth gear B3 sleeve the output shaft 5. The second synchronizer S2 is connected to the output shaft 5, and the output shaft 5 is connected to or disconnected from the third gear A3 or the fourth gear B3 via the second synchronizer S2. Specifically, as shown in FIG. 1, when the second synchronizer S2 moves left to engage the third gear A3, the output shaft 5 is connected to the third gear A3. When the second synchronizer S2 moves right to engage the fourth gear B3, the output shaft 5 is connected to the fourth gear B3. When the second synchronizer S2 is in the middle position, the output shaft 5 is not connected to either the third gear A3 or the fourth gear B3.

The first transmission shaft 6 is connected to the shaft of the first motor 2, and the first transmission shaft 6 is connected to the fifth gear A2 and the sixth gear B2. The fifth gear A2, the first gear A1, and the third gear A3 drive each other. Specifically, the fifth gear A2 meshes with both the first gear A1 and the third gear A3, and the first gear A1 does not mesh with the third gear A3. The sixth gear B2, the second gear B1, and the fourth gear B3 drive each other. Specifically, the sixth gear B2 meshes with both the second gear B1 and the fourth gear B3, and the second gear B1 does not mesh with the fourth gear B3.

The second transmission shaft 7 is connected to the shaft of the second motor 3, and the second transmission shaft 7 is connected to the output shaft 5 via a transmission mechanism 8. The transmission mechanism 8 includes a seventh gear C2 connected to the second transmission shaft 7 and an eighth gear C3 connected to the output shaft 5, and the seventh gear C2 meshes with the eighth gear C3.

The transmission ratio of the fourth gear B3 to the sixth gear B2 is greater than the transmission ratio of the eighth gear C3 to the seventh gear C2; the transmission ratio of the eighth gear C3 to the seventh gear C2 is greater than the transmission ratio of the third gear A3 to the fifth gear A2. For example, the transmission ratio of the fourth gear B3 to the sixth gear B2 may be set to 12:1, the transmission ratio of the eighth gear C3 to the seventh gear C2 may be set to 8:1, and the transmission ratio of the third gear A3 to the fifth gear A2 may be set to 6:1. In this way, when the first motor 2 drives the output shaft 5, there can be a large transmission ratio and a small transmission ratio. The large transmission ratio reduces the output speed and increases the torque, which is suitable for the startup phase of the car. The small transmission ratio increases the output speed, suitable for high-speed driving of the car, reducing power consumption. The second motor has a medium transmission ratio, facilitating engagement after the car starts. Therefore, the set gear positions are relatively reasonable.

The output shaft 5 is also connected to an output gear D1. The central axis of the second transmission shaft 7 overlaps with that of the first transmission shaft 6. The second transmission shaft 7 and the first transmission shaft 6 are located between the input shaft 4 and the output shaft 5. The input shaft 4, the output shaft 5, the first transmission shaft 6, and the second transmission shaft 7 may be mounted on a box. The first synchronizer S1 and/or the second synchronizer S2 may be replaced by a clutch.

In this embodiment, the engine 1 has four gear positions, or there are four transmission ratios of the engine 1 to the output shaft 5. The first synchronizer S1 engages the left gear, and the second synchronizer S2 engages the right gear. The torque of the engine 1 is transmitted to the output shaft 5 via the first gear A1, the fifth gear A2, the sixth gear B2, and the fourth gear B3. The gear pair formed by the first gear A1 and the fifth gear A2 and the gear pair formed by the sixth gear B2 and the fourth gear B3 form the first gear position/transmission ratio. The first synchronizer S1 engages the left gear, and the second synchronizer S2 engages the left gear. The torque of the engine 1 is transmitted to the output shaft 5 via the first gear A1, the fifth gear A2, and the third gear A3. The gear pair formed by the first gear A1 and the fifth gear A2 and the gear pair formed by the fifth gear A2 and the third gear A3 form the second gear position/transmission ratio. The first synchronizer S1 engages the right gear, and the second synchronizer S2 engages the left gear. The torque of the engine 1 is transmitted to the output shaft 5 via the second gear B1, the sixth gear B2, the fifth gear A2, and the third gear A3. The gear pair formed by the second gear B1 and the sixth gear B2 and the gear pair formed by the fifth gear A2 and the third gear A3 form the third gear position/transmission ratio. The first synchronizer S1 engages the right gear, and the second synchronizer S2 engages the right gear. The torque of the engine 1 is transmitted to the output shaft 5 via the second gear B1, the sixth gear B2, and the fourth gear B3. The gear pair formed by the second gear B1 and the sixth gear B2 and the gear pair formed by the sixth gear B2 and the fourth gear B3 form the fourth gear position/transmission ratio.

In this embodiment, when the first motor 2 and the second motor 3 are mounted on the vehicle chassis, they are electrically connected to the power battery mounted on the vehicle chassis via a controller.

In this embodiment, the control and gear shifting can be achieved as shown in Table 1 below:

TABLE 1

| | | | | First | Second |
|---|---|---|---|---|---|
| | | First | Second | synchronizer | synchronizer |
| | Engine 1 | motor 2 | motor 3 | S1 | S2 |
| EV I | Off | Drive | D/G | | Right |
| EV II | Off | | Drive | | |
| EV III | Off | Drive | D/G | | Left |
| EV I/II | Off | Drive | Drive | | Right |
| EV II/III | Off | Drive | Drive | | Left |
| EV⇒series | Off⇒start | Drag the | Drive | Left (or | |
| HEV | | engine | | right) | |
| Series | Drive | Generate | Drive | Left (or | |
| HEV | | electricity | | right) | |
| Series⇔first | Follow | Adjust | Drive | Left | Off⇔right |
| gear | up | synchronization | | | |
| HEV first | Drive | D/G | D/G | Left | Right |
| gear | | | | | |
| First | Follow | Adjust | Drive | Left | Right⇔left |
| gear⇔second | up | synchronization | | | |
| gear | | | | | |
| HEV | Drive | D/G | D/G | Left | Left |
| second gear | | | | | |
| Second | Follow | Adjust | Drive | Left⇔right | Left⇔right |
| gear⇔third | up | synchronization | | | |
| gear | | | | | |
| HEV third | Drive | D/G | D/G | Right | Right |
| gear | | | | | |
| Third | Follow | Adjust | Drive | Right | Right⇔left |
| gear⇔fourth | up | synchronization | | | |
| gear | | | | | |
| HEV | Drive | D/G | D/G | Right | Left |
| fouth gear | | | | | |

Note:
1. D/G indicates that the motor is connected to and follows a transmission chain, and can switch to drive or generate electricity as needed.
2. The positions of the first synchronizer S1 and the second synchronizer S2 correspond to the positions shown in FIG. 1.

2. The positions of the first synchronizer S1 and the second synchronizer S2 correspond to the positions shown in FIG. 1.

It can be clearly seen from Table 1 above that during the gear shifting process, the motors are involved in driving, achieving shifting without power interruption and effectively improving the smoothness of vehicle driving.

In this embodiment, during operation in various modes, the main settings and control of the components are further described as follows:

The pure EV (electric vehicle) operating mode:

The first motor 2 drives in the EV mode: The engine 1 is turned off, and the first synchronizer S1 is in the middle position, disconnecting from the transmission chain. The second synchronizer S2 moves to the right to engage the fourth gear B3 (or moves to the left to engage the third gear A3), and the first motor 2 meshes with the fourth gear B3 and the sixth gear B2 (or with the third gear A3 and the fifth gear A2) to drive the output shaft 5. The first motor 2 has two gear positions: a large transmission ratio of the fourth gear B3/sixth gear B2 and a small transmission ratio of the fifth gear A2/third gear A3.

The second motor 3 drives in the EV mode: The engine 1 is turned off, and the first synchronizer S1 is in the middle position, disconnecting from the transmission chain. The second synchronizer S2 is in the middle position, disconnecting the first motor 2 from the transmission chain. The second motor 3 meshes with the seventh gear C2 and the eighth gear C3 to drive the output shaft 5. The second motor 3 has a medium transmission ratio.

In the “first motor 2 driving EV mode”, the second motor 3 is always connected to the transmission chain and can switch to the electric state at any time to drive together with the first motor 2. In the EV operating mode, the first motor 2 and the second motor 3 can drive together, and the first motor 2 can have a large reduction ratio (torque increase ratio), so the torque requirements for both motors are not high. Because the second motor 3 has a medium transmission ratio and the first motor 2 has two transmission ratios, the rotation speed requirements for both motors are moderate.

Gear shifting in the EV (pure electric drive) operating mode without power interruption:

In the EV operating mode, the first motor 2 shifts from a large transmission ratio EV I to a small transmission ratio EV III: The first motor 2 transfers the load to the second motor 3, and the second motor 3 continues to drive. After the first motor 2 is unloaded, the second synchronizer S2 disengages to the middle position. The first motor 2 synchronizes, and after the third gear A3 is synchronized with the output shaft 5, the second synchronizer S2 shifts to the left to engage the gear. The torque distribution is adjusted to complete the gear shifting.

The first motor 2 shifts from a small transmission ratio EV III to a large transmission ratio EV I: The first motor 2 transfers the load to the second motor 3, and the second motor 3 continues to drive. After the first motor 2 is unloaded, the second synchronizer S2 disengages to the middle position. The first motor 2 synchronizes, and after the fourth gear B3 is synchronized with the output shaft 5, the second synchronizer S2 shifts to the right to engage the gear. The torque distribution is adjusted to complete the gear shifting.

It can be seen that in the EV operating mode, when the first motor 2 shifts the gear, the second motor 3 always drives and compensates for the torque of the first motor 2, so the shifting process has no power interruption.

A switch from the pure EV (electric vehicle) operating mode to the HEV (hybrid electric vehicle) series operating mode:

The vehicle can smoothly switch from EV operating mode to HEV series drive operating mode: EV mode. The engine 1 is turned off, the first synchronizer S1 is in the middle position, and the second motor 3 meshes with the seventh gear C2 and the eighth gear C3 to drive the output shaft 5. To switch from the EV operating mode to the HEV operating mode, the following steps are implemented: The first synchronizer S1 moves to the right to engage the gear, and the first motor 2 drags and starts the engine 1 via the sixth gear B2, the second gear B1, the first synchronizer S1, and the input shaft 4. Then, the engine 1 enters the working state, outputs power, and drives the first motor 2 to generate electricity to charge the power battery. The power battery supplies power to the second motor 3, the second motor 3 drives the vehicle, and the system enters the HEV series drive operating mode.

A switch from the series mode to the parallel mode:

When the vehicle speed is low, the system operates in the HEV series drive mode; as the vehicle speed increases, the system enters the HEV parallel drive mode. The engine 1 has four gear positions, meaning the engine 1 can directly drive at four various transmission ratios. The operating efficiency of the engine 1 is better than those of three-gear and less than three-gear series-parallel hybrid systems. The first motor 2 has two gear positions, which can achieve a good balance between acceleration performance and fuel economy and reduce the requirements for torque and speed. This is conducive to reducing cost, weight, and NVH (noise, vibration, and harshness). The second motor 3 has a medium transmission ratio, with the torque and rotation speed of the second motor 3 required to be moderate.

The HEV series operating mode can smoothly switch to the HEV parallel drive first gear: the HEV series mode. The first synchronizer S1 moves to the left to engage the gear, connecting the first transmission shaft 6 with the input shaft 4. The engine 1 drives the first motor 2 to generate electricity; the second motor 3 meshes with the seventh gear C2 and the eighth gear C3 to drive the output shaft 5. To switch from the series drive mode to the parallel drive mode, the following steps are implemented: The second motor 3 continues to drive, and the vehicle is subjected to no power interruption. The first motor 2 drives the engine 1 to adjust the speed, and when the fourth gear B3 is synchronized with the output shaft 5, the second synchronizer S2 moves to the right to engage the gear. Then, the torque distribution is adjusted, and the first gear parallel drive mode is enabled. The engine 1 drives the output shaft 5 via the input shaft 4, the first gear A1, the fifth gear A2, the sixth gear B2, and the fourth gear B3.

Similarly, the system can switch from HEV series drive mode to other HEV parallel drive gear positions.

In the HEV (hybrid electric vehicle) operating mode, gear shifting is performed without power interruption.

The system can perform gear shifting without power interruption. During the gear shifting, the engine 1 unloads (output torque is reduced to zero) and the second motor 3 compensates for the unloading of the engine 1, continuously driving the output shaft 5 via the seventh gear C2 and the eighth gear C3. After the original gear synchronizer disengages, the first motor 2 drives the engine 1 to adjust synchronization. When the new gear-position gear is synchronized with the relevant shaft, the synchronizer engages the gear; and then the torque distribution is adjusted to complete the gear shifting.

The HEV first gear position can smoothly switch to the HEV second gear position. The engine 1 unloads, and the second motor 3 increases torque compensation. The second motor 3 continues to drive the output shaft 5 via the seventh gear C2 and the eighth gear C3, and the vehicle is subjected to no power interruption. After the torque of the engine 1 is reduced to zero, the second synchronizer S2 can be easily disengaged from the right gear to the middle position, and then the first motor 2 drives the engine 1 to adjust the speed, synchronizing the third gear A3 with the output shaft 5. Next, the second synchronizer S2 moves to the left to engage the gear, the engine 1 drives the output shaft 5 via the input shaft 4, the first gear A1, the fifth gear A2, and the third gear A3, and the engine 1 engages the second gear.

The HEV second gear position can smoothly switch to the HEV third gear position. The engine 1 unloads, and the second motor 3 increases torque compensation. The second motor 3 continues to drive the output shaft 5 via the seventh gear C2 and the eighth gear C3, and the vehicle is subjected to no power interruption. After the torque of the engine 1 is reduced to zero, the first synchronizer S1 and the second synchronizer S2 can be easily disengaged from the prior gears to the middle position. The first motor 2 adjusts synchronization, synchronizing the second gear B1 with the input shaft 4. S1 moves to the right to engage the gear, and the first motor 2 drives the engine 1 to adjust the speed, synchronizing the fourth gear B3 with the output shaft 5. Next, the second synchronizer S2 moves to the right to engage the gear, the engine 1 drives the output shaft 5 via the input shaft 4, the second gear B1, the sixth gear B2, and the fourth gear B3, and the engine 1 engages the third gear.

The HEV third gear position can smoothly switch to the HEV fourth gear position. The engine 1 unloads, and the second motor 3 increases torque compensation. The second motor 3 continues to drive the output shaft 5 via the seventh gear C2 and the eighth gear C3, and the vehicle is subjected to no power interruption. After the torque of the engine 1 is reduced to zero, the second synchronizer S2 can be easily disengaged from the right gear to the middle position. Next, the first motor 2 drives the engine 1 to adjust the speed, synchronizing the third gear A3 with the output shaft 5, and the second synchronizer S2 moves to the left to engage the gear. The engine 1 drives the output shaft 5 via the input shaft 4, the second gear B1, the sixth gear B2, the fifth gear A2, and the third gear A3, and the engine 1 engages the fourth gear.

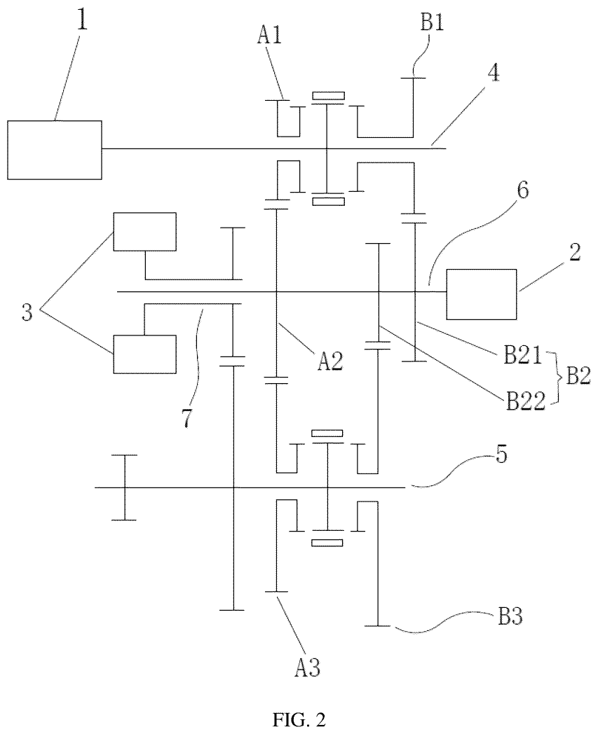

In Embodiment 2, as shown in FIG. 2, a variable transmission system for a hybrid electric vehicle is provided, which is different from Embodiment 1 in that the second transmission shaft 7 sleeves the first transmission shaft 6, and the sixth gear B2 includes a gear B21 and a gear B22 that are connected as a whole, where the gear B21 meshes with the second gear B1, and the gear B22 meshes with the fourth gear B3. This facilitates the design of a more proper speed ratio.

In this embodiment, the engine 1 has four gear positions, or there are four transmission ratios of the engine 1 to the output shaft 5. The gear pair formed by the first gear A1 and the fifth gear A2 and the gear pair formed by the gear B22 in the sixth gear B2 and the fourth gear B3 form the first transmission ratio. The gear pair formed by the first gear A1 and the fifth gear A2 and the gear pair formed by the fifth gear A2 and the third gear A3 form the second transmission ratio. The gear pair formed by the second gear B1 and the gear B21 in the sixth gear and the gear pair formed by the fifth gear A2 and the third gear A3 form the third transmission ratio. The gear pair formed by the second gear B1 and the gear B21 in the sixth gear and the gear pair formed by the gear B22 of the sixth gear and the fourth gear B3 form the fourth transmission ratio.

Other structural components and arrangements, such as the engine 1, the first motor 2, and the second motor 3, are the same as those in Embodiment 1. The control and implemented functions of this embodiment are basically the same as those in Embodiment 1, which can be referred to for explanation, and details are not repeated here.

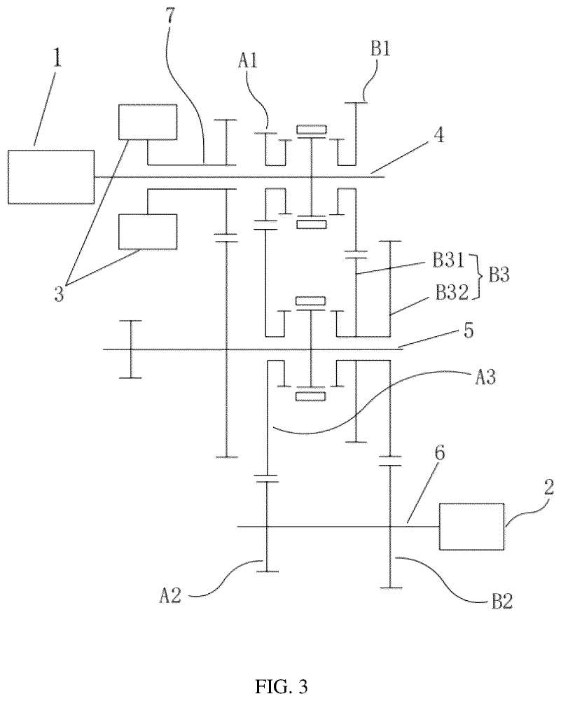

In Embodiment 3, as shown in FIG. 3, a variable transmission system for a hybrid electric vehicle is provided, which is different from Embodiment 1 in that the output shaft 5 is located between the input shaft 4 and the first transmission shaft 6. The third gear A3 meshes with both the first gear A1 and the fifth gear A2, and the first gear A1 does not mesh with the fifth gear A2. The fourth gear B3 meshes with both the second gear B1 and the sixth gear B2, and the second gear B1 does not mesh with the sixth gear B2. This embodiment provides a new arrangement structure.

As another modification, to facilitate the design of a proper transmission ratio, the fourth gear B3 in this embodiment can be composed of two gears that are connected as a whole, where a first gear of the fourth gear B3 meshes with the second gear B1, and a second gear of the fourth gear B3 meshes with the sixth gear B2.

Other structural components and arrangements, such as the engine 1, the first motor 2, and the second motor 3, are the same as those in Embodiment 1. The control and implemented functions of this embodiment are basically the same as those in Embodiment 1, which can be referred to for explanation, and details are not repeated here.

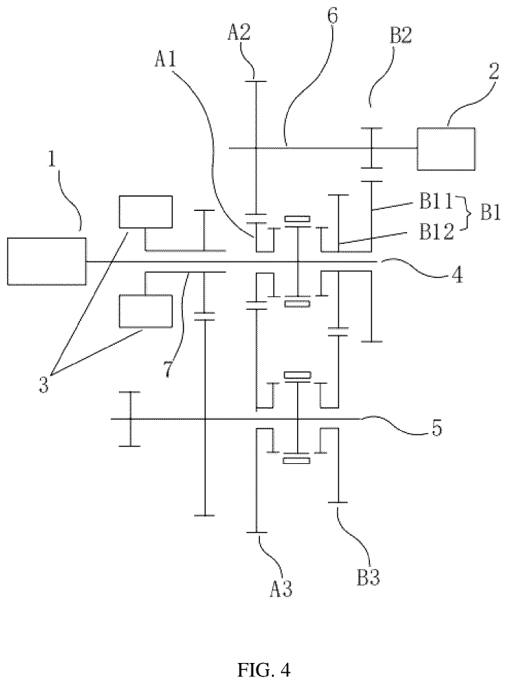

In Embodiment 4, as shown in FIG. 4, a variable transmission system for a hybrid electric vehicle is provided, which differs from Embodiment 1 in that the input shaft 4 is located between the output shaft 5 and the first transmission shaft 6. The first gear A1 meshes with both the third gear A3 and the fifth gear A2, and the third gear A3 and the fifth gear A2 do not mesh with each other. The second gear B1 meshes with both the fourth gear B3 and the sixth gear B2, and the fourth gear B3 and the sixth gear B2 do not mesh with each other. This embodiment also provides a new arrangement structure.

As another modification, to facilitate the design of a proper transmission ratio, the second gear B1 in this embodiment can be composed of two gears that are connected as a whole, where a first gear of the second gear B1 meshes with the sixth gear B2, and a second gear of the second gear B1 meshes with the fourth gear B3.

Other structural components and arrangements, such as the engine 1, the first motor 2, and the second motor 3, are the same as those in Embodiment 1. The control and implemented functions of this embodiment are basically the same as those in Embodiment 1, which can be referred to for explanation, and details are not repeated here.

Although the present invention is described with reference to the preferred embodiments, those skilled in the art should understand that various changes may be made to the present invention in form and detail without departing from the spirit and scope of the present invention as defined by the appended claims, and these changes fall into the protection scope of the present invention.

1. A variable transmission system for a hybrid electric vehicle, comprising an engine, a first motor, a second motor, a first gear, a second gear, a third gear, a fourth gear, an input shaft, an output shaft, a first synchronizer, and a second synchronizer, wherein the input shaft is connected to the engine, the first gear and the second gear sleeve the input shaft, the first synchronizer is connected to the input shaft, the input shaft is connected to or disconnected from the first gear or the second gear via the first synchronizer, the third gear and the fourth gear sleeve the output shaft, the second synchronizer is connected to the output shaft, and the output shaft is connected to or disconnected from the third gear or the fourth gear via the second synchronizer; and
a shaft of the first motor is connected to a fifth gear and a sixth gear, the fifth gear, the first gear, and the third gear drive each other, the sixth gear, the second gear, and the fourth gear drive each other, and a shaft of the second motor is connected to the output shaft via a transmission mechanism.

2. The variable transmission system for a hybrid electric vehicle according to claim 1, wherein the fifth gear meshes with both the first gear and the third gear, the first gear does not mesh with the third gear, the sixth gear meshes with both the second gear and the fourth gear, and the second gear does not mesh with the fourth gear.

3. The variable transmission system for a hybrid electric vehicle according to claim 2, wherein the sixth gear comprises two gears that are connected as a whole, a first one of the two gears meshes with the second gear, and a second one of the two gears meshes with the fourth gear.

4. The variable transmission system for a hybrid electric vehicle according to claim 1, wherein the third gear meshes with both the first gear and the fifth gear, and the first gear does not mesh with the fifth gear, the fourth gear meshes with both the second gear and the sixth gear, and the second gear does not mesh with the sixth gear.

5. The variable transmission system for a hybrid electric vehicle according to claim 4, wherein the fourth gear comprises two gears that are connected as a whole, a first one of the two gears meshes with the second gear, and a second one of the two gears meshes with the sixth gear.

6. The variable transmission system for a hybrid electric vehicle according to claim 1, wherein the first gear meshes with both the third gear and the fifth gear, the third gear does not mesh with the fifth gear, the second gear meshes with both the fourth gear and the sixth gear, and the fourth gear does not mesh with the sixth gear.

7. The variable transmission system for a hybrid electric vehicle according to claim 6, wherein the second gear comprises two gears that are connected as a whole, a first one of the two gears meshes with the sixth gear, and a second one of the two gears meshes with the fourth gear.

8. The variable transmission system for a hybrid electric vehicle according to claim 1, wherein the transmission mechanism comprises a seventh gear connected to the shaft of the second motor and an eighth gear connected to the output shaft, and the seventh gear meshes with the eighth gear.

9. The variable transmission system for a hybrid electric vehicle according to claim 8, further comprising a first transmission shaft and a second transmission shaft, wherein the first transmission shaft is connected to the shaft of the first motor, and the fifth gear and the sixth gear are connected to the first transmission shaft, the second transmission shaft is connected to the shaft of the second motor, and the seventh gear is connected to the second transmission shaft.

10. The variable transmission system for a hybrid electric vehicle according to claim 1, wherein at least one of the first synchronizer or the second synchronizer is a clutch.

11. The variable transmission system for a hybrid electric vehicle according to claim 1, wherein the variable transmission system has one or more of the following operation modes:
a pure electric mode in which at least one of the first motor and/or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

12. The variable transmission system for a hybrid electric vehicle according to claim 2, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

13. The variable transmission system for a hybrid electric vehicle according to claim 3, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

14. The variable transmission system for a hybrid electric vehicle according to claim 4, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

15. The variable transmission system for a hybrid electric vehicle according to claim 5, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

16. The variable transmission system for a hybrid electric vehicle according to claim 6, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

17. The variable transmission system for a hybrid electric vehicle according to claim 7, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

18. The variable transmission system for a hybrid electric vehicle according to claim 8, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

19. The variable transmission system for a hybrid electric vehicle according to claim 9, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.

20. The variable transmission system for a hybrid electric vehicle according to claim 10, wherein the variable transmission system has one or more of the following operation modes:
a pure electric mode in which at least one of the first motor or the second motor drives the output shaft and is configured to achieve power shifting;
a series mode in which the engine drives the first motor to generate electricity, and the second motor drives the output shaft; and
a parallel mode in which the engine drives the output shaft based on a selected gear position, and the first motor and the second motor are separately configured to drive, generate electricity, or idle and achieve gear shifting.
